(19) United States
(12) Patent Application Publication
(10) Pub. No.: US 2019/0270480 A1
(43) Pub. Date: Sep. 5, 2019

(54) APPARATUS AND METHOD FOR TURNING STEERABLE VEHICLE WHEELS

(71) Applicant: TRW Automotive U.S. LLC, Livonia, MI (US)

(72) Inventor: Joseph E. Harter, JR., Kokomo, IN (US)

(21) Appl. No.: 16/334,039

(22) PCT Filed: Oct. 26, 2017
(86) PCT No.: PCT/US17/58456

§ 371 Date: Mar. 18, 2019

Related U.S. Application Data
(60) Provisional application No. 62/413,001, filed on Oct. 26, 2016.

(51) Int. Cl. B62D 5/065; B62D 5/06; B62D 6/00

(52) U.S. Cl. CPC B62D 5/065; B62D 6/008; B62D 5/064

(57) ABSTRACT

A method for turning steerable wheels of a vehicle includes supplying fluid under pressure to a hydraulic power steering motor with a pump driven by an engine of the vehicle to turn the steerable wheels during operation of the engine. It is determined if the engine of the vehicle is shut down. An electric motor applies power assist to turn the steerable wheels when the engine is shut down. An apparatus for turning steerable vehicle wheels includes a hydraulic power steering motor assembly connected with the steerable vehicle wheels. A pump connected with the power steering motor assembly is driven by an engine of the vehicle to supply fluid under pressure to the power steering motor assembly during operation of the engine. An electric motor connected with the steerable vehicle wheels applies power assist to turn the steerable vehicle wheels. A controller operates the electric motor to apply the power assist when the engine is shut down.

### TECHNICAL FIELD

The present invention is directed to an apparatus and method for use in turning steerable vehicle wheels and, more specifically, to an apparatus and method for reducing the energy used to turn steerable vehicle wheels.

### BACKGROUND OF THE INVENTION

In a known power steering system, an engine driven pump provides a fixed volume of fluid output per revolution during operation of the pump. Therefore, the rate of flow of fluid from the engine driven pump is proportional to engine speed. The pump in this known power steering system is sized to provide an acceptable rate of fluid flow when the engine is idling.

It is desired to improve fuel economy and reduce environmental pollutants of vehicles, including commercial vehicles. One method is to shut down the vehicle engine during situations where power is not required, such as coasting when the vehicle is travelling downhill, and/or slowing down in traffic and off ramps. It has been determined that these situations occur often enough to justify engine shut down for reduced fuel consumption. One primary concern during engine shut down during coast is loss of hydraulic assist for steering systems. Commercial vehicles typically use an engine driven hydraulic pump to drive a hydraulic steering gear for power assist. Engine shut down would stop hydraulic flow and power steering assist would be lost.

Also, several problems occur in the typical power steering system during operation at cruise or highway speeds. The system is designed to be capable of providing adequate power steering assist when the vehicle is static. A large amount of force is required to turn the wheels when the vehicle is not moving and/or moving at a speed below a predetermined speed. The size of the hydraulic pump is determined by the force required to steer a static vehicle when the vehicle is running at low RPMs, idle. When a vehicle is moving, far less power assist is needed, especially at a speed above the predetermined speed. When a vehicle is moving, the engine is turning at higher RPMs. The engine turning at the high RPMs and turning the power steering pump produce excess flow which in turn produces excess heat in the system. The excess flow is extra work that the engine is doing and wasted energy. This energy waste is being targeted by commercial vehicle companies and they are seeking solutions to reduce or eliminate this energy waste. Pumps that have a reduced displacement are one possible solution to reduce this excess.

### SUMMARY OF THE INVENTION

A method for turning steerable wheels of a vehicle includes supplying fluid under pressure to a hydraulic power steering motor with a pump driven by an engine of the vehicle to turn the steerable wheels during operation of the engine. It is determined if the engine of the vehicle is shut down. An electric motor applies power assist to turn the steerable wheels when the engine is shut down.

In another aspect of the present invention, an apparatus for turning steerable vehicle wheels includes a hydraulic power steering motor assembly connected with the steerable vehicle wheels. A pump connected with the power steering motor assembly is driven by an engine of the vehicle to supply fluid under pressure to the power steering motor assembly during operation of the engine. An electric motor connected with the steerable vehicle wheels applies power assist to turn the steerable vehicle wheels. A controller operates the electric motor to apply the power assist when the engine is shut down.

The apparatus of the present invention includes many different features which may advantageously be utilized together as disclosed herein. Alternatively, the features may be utilized separately or in various combinations with each other and/or with features from the prior art.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 Is a schematic illustration of a power steering apparatus constructed and operated in accordance with the present invention.

### DESCRIPTION

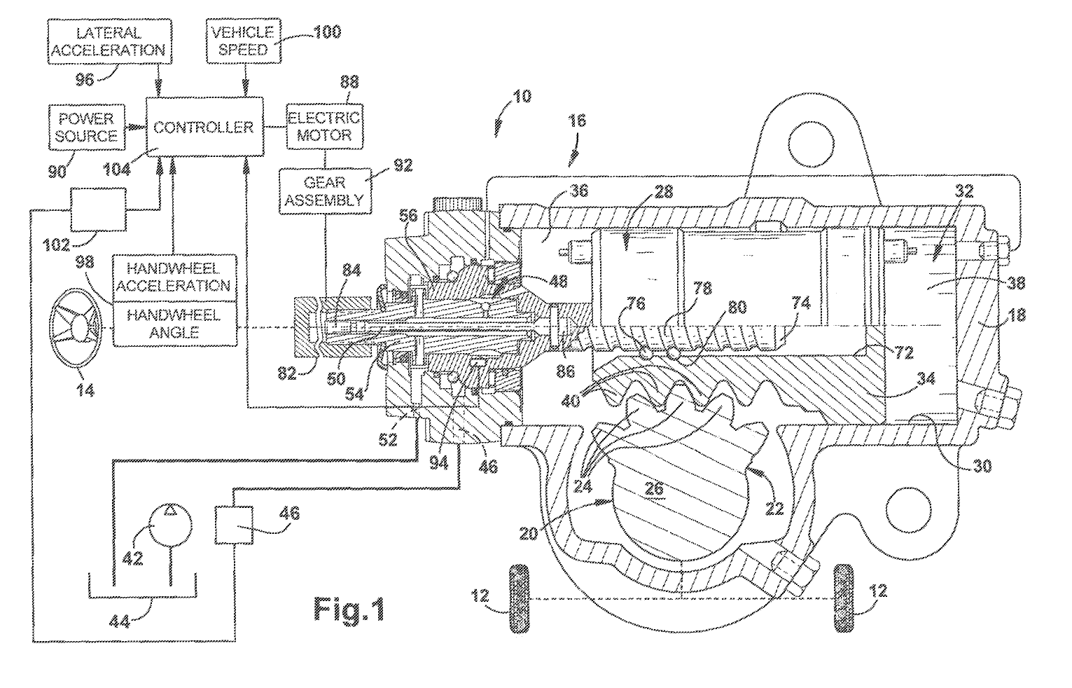

An apparatus 10, constructed in accordance with the present invention, is illustrated in FIG. 1. The apparatus 10 is a vehicle power steering system for turning steerable wheels 12 of a vehicle in response to rotation of a hand wheel 14 of the vehicle.

The apparatus 10 includes a hydraulic power steering gear 16. The steering gear 16 includes a housing 18 and a drive mechanism 20. The drive mechanism 20 is moved in response to rotation of the hand wheel 14 of the vehicle. The motion of the drive mechanism 20 results in a turning of the steerable wheels 12 of the vehicle.

The drive mechanism 20 includes a sector gear 22 having a plurality of teeth 24. The sector gear 22 is fixed on an output shaft 26 that extends outwardly through an opening in the housing 18. The output shaft 26 is typically connected to a pitman arm that is connected to the steering linkage of the vehicle. The dashed lines in FIG. 1 represent the pitman arm and steering linkage. Thus, as the sector gear 22 rotates, the output shaft 26 is rotated to operate the steering linkage. As a result, the steerable wheels 12 of the vehicle are turned.

The steering gear 16 further includes a hydraulic motor 28 for moving the drive mechanism 20. The hydraulic motor 28 is located within the housing 18 of the steering gear 16. The housing 18 of the steering gear 16 has an inner cylindrical surface 30 defining a chamber 32. A piston 34 is located within the chamber 32 and divides the chamber 32 into opposite chamber portions 36 and 38. One chamber portion 36 is located on a first side of the piston 34 and the other chamber portion 38 is located on a second side of the piston 34. The piston 34 creates a seal between the respective chamber portions 36 and 38 and is capable of axial movement within the chamber 32. This axial movement of the piston 34 results in an increase in volume of one chamber portion 36 or 38 and a corresponding decrease in volume of the other chamber portion 36 or 38.

A series of rack teeth 40 is formed on the periphery of the piston 34. The rack teeth 40 act as an output for the hydraulic motor 28 and mesh with the teeth 24 formed on the sector gear 22 of the drive mechanism 20.

A pump 42 pumps hydraulic fluid from a reservoir 44 to the hydraulic motor 28. The engine 46 of the vehicle drives the pump 42 during operation of the engine 46. The pump 42 forces hydraulic fluid into an inlet 46 of the housing 18. The inlet 46 directs the flow of the fluid to a directional control valve 48.

The directional control valve 48 directs the fluid to an appropriate chamber portion 36 or 38 of the hydraulic motor 28. The flow of hydraulic fluid toward one of the chamber portions 36 or 38 increases the pressure within that chamber portion 36 or 38. When the pressure of one chamber portion 36 or 38 increases relative to the pressure of the other chamber portion 36 or 38, the piston 34 moves axially and the volume of the higher-pressure chamber portion 36 or 38 increases. The volume of the higher-pressure chamber portion 36 or 38 increases until the pressure within each chamber portion 36 and 38 equalizes. As the volume of one chamber portion 36 or 38 increases, the volume of the other chamber portion 36 or 38 decreases. The decreasing chamber portion 36 or 38 is vented to allow a portion of the fluid contained in the decreasing chamber portion 36 or 38 to escape. The escaping fluid exits the housing 18 via a return 52 and is directed into the reservoir 44.

The piston 34 of the hydraulic motor 28 contains a bore 72, partially shown in FIG. 1, which is open toward the directional control valve 48. A valve sleeve part 56 of the control valve 48 and a follow-up member 74 form an integral one-piece unit that is supported for rotation relative to the piston 34 by a plurality of balls 76. The outer periphery 78 of the follow-up member 74 is threaded. The plurality of balls 76 interconnects the threaded outer periphery 78 of the follow-up member 74 with an internal thread 80 formed in the bore 72 of the piston 34. As a result of the interconnecting plurality of balls 76, axial movement of the piston 34 causes the follow-up member 74 and the valve sleeve part 56 to rotate. The rotation of the follow-up member 74 and the valve sleeve part 56 returns the directional control valve 48 to a neutral position.

A valve core part 54 of the directional control valve 48 is fixedly connected to an input shaft 82 (FIG. 1). As shown schematically by dashed lines in FIG. 1, the input shaft 82 is fixedly connected to the hand wheel 14 of the vehicle. Rotation of the hand wheel 14 results in rotation of the input shaft 82 and rotation of the valve core part 54.

A torsion bar 50 has a first end 84 and a second end 86. The first end 84 of the torsion bar 50 is fixed relative to the input shaft 82 and the valve core part 54. The second end 86 of the torsion bar 50 is fixed relative to the valve sleeve part 56 and the follow-up member 74. At least a portion of the torsion bar 50 extends through an axially extending bore 72 in the valve core part 54.

When the resistance to turning of the steerable wheels 12 of the vehicle is below a predetermined level, rotation of the hand wheel 14 is transferred through the torsion bar 50 and causes rotation of the follow-up member 74. As a result, the directional control valve 48 remains in the neutral position. Rotation of the follow-up member 74 causes movement of the piston 34 and results in turning of the steerable wheels 12. When resistance to turning the steerable wheels 12 of the vehicle is at or above the predetermined level, rotation of the follow-up member 74 is resisted. As a result, rotation of the hand wheel 14 rotates the first end 84 of the torsion bar 50 relative to the second end 86 of the torsion bar 50. The rotation of the first end 84 of the torsion bar 50 relative to the second end 86 of the torsion bar 50 applies a torque across the torsion bar 50 and causes the valve core part 54 to rotate relative to the valve sleeve part 56. When the valve core part 54 rotates relative to the valve sleeve part 56, hydraulic fluid is directed toward one of the chamber portions 36 or 38. As a result, the piston 34 moves within the chamber 32. Movement of the piston 34 results in turning of the steerable wheels 12 of the vehicle, as well as, rotation of the follow-up member 74. As discussed above, rotation of the follow-up member 74 rotates the valve sleeve part 56 until the directional control valve 48 is again in the neutral position. When the directional control valve 48 is in the neutral position, the torque across the torsion bar 50 is removed and the first end 84 of the torsion bar 50 is no longer rotated relative to the second end 86 of the torsion bar 50.

The apparatus 10 also includes an electric motor 88. The electric motor 88 may be located in the cab of the vehicle or under the hood of the vehicle on the steering gear 16 and may be of any conventional design. The electric motor 88 receives electric power from a power source 90, preferably the vehicle battery. An output shaft of the electric motor 88 is connected to the input shaft 82. Preferably, a gear assembly 92 is used to connect the output shaft of the electric motor 88 to the input shaft 82. When the electric motor 88 receives electric power, the output shaft of the electric motor 88 rotates the input shaft 82.

The apparatus 10 includes a torque sensor 94 for sensing column torque and outputting a signal indicative of the column torque. Column torque is the torque across the torsion bar 50. The apparatus 10 also includes a plurality of vehicle condition sensors 96, 98, 100, 102 and a controller 104. Preferably, the vehicle condition sensors include a lateral acceleration sensor 96, a hand wheel rotation sensor 98, a vehicle speed sensor 100 and an engine sensor 102. Each sensor 96, 98, 100 and 102 is electrically connected to the controller 104.

The lateral acceleration sensor 96 continuously senses the lateral acceleration of the vehicle and generates an electrical signal indicative of the sensed lateral acceleration. The hand wheel rotation sensor 98 continuously senses the magnitude, rate, and acceleration of rotation of the vehicle hand wheel 14 and generates electrical signals indicative of these parameters. The vehicle speed sensor 100 continuously senses the vehicle speed and generates an electrical signal indicative of the speed. The engine sensor 102 continuously senses the operation of the engine 46 and generates a signal indicative of the engine operation.

The controller 104 receives the signals generated by the lateral acceleration sensor 96, the hand wheel rotation sensor 98, the vehicle speed sensor 100 and the engine sensor 102. Additionally, the controller 104 receives the column torque signal from the torque sensor 94. The controller 104 analyzes the respective signals and generates a signal for controlling the electric motor 88. The controller 104 may cause the electric motor 88, through the gear assembly 92, to rotate the input shaft 82. When the input shaft 82 rotates, the torsion bar 50 rotates causing axial movement of the piston 34 and turning of the steerable wheels 12. As a result, the electric motor 88 may also assist the operator in turning the steerable wheels 12.

The controller 104 receives the signals generated by the lateral acceleration sensor 96, the hand wheel rotation sensor 98, the vehicle speed sensor 100 and the engine sensor 102 to determine if the vehicle engine 46 is shut down and the vehicle is moving in coast mode. When the vehicle engine 46 is shut down, the pump 42 does not pump hydraulic fluid to the hydraulic motor 28. Therefore, the hydraulic motor 28 is inoperative and does not provide power assist for turning the steerable wheels 12. When the vehicle controller 104 determines that the vehicle engine 46 is shut down and the vehicle is moving in coast mode, the controller determines a desired torque to be applied to the hand wheel 14 and the input shaft 82 by the electric motor 88. The controller 104 causes the electric motor 88 to rotate the hand wheel 14 and the input shaft 82 to apply a steering assist force to turn the steerable wheels 12 since the pump 42 does not provide steering assist. The controller The amount of power assist required is approximately 100 Newton meters of torque or less when the vehicle is traveling at speeds above 20 mph.

When the vehicle is traveling at speeds above a predetermined speed, such as highway speed, the pump 42 may provide reduced or zero hydraulic flow to the power steering motor 28 to save energy used by the pump. When the pump 42 provides reduced or zero hydraulic flow to the power steering motor 28, the power steering motor does not provide power assist for turning the steerable wheels 12. The pump 42 may have a variable flow that is reduced and/or the pump may be disconnected from the engine using a clutch to reduce the flow from the pump 42.

When the vehicle controller 104 determines that the speed of the vehicle is above the predetermined speed, the controller may reduce the hydraulic flow provided by the pump 42. The controller 104 causes the electric motor 88 to rotate the input shaft 82 to apply a steering assist force to turn the steerable wheels 12 since the pump 42 does not provide any steering assist. A reduction in flow provided by the pump 42 to turn the steerable wheels 12 reduces the amount of heat produced in the system to save energy and improve reliability.

The controller 104 communicates directly with the lateral acceleration sensor 96, the hand wheel rotation sensor 98, the vehicle speed sensor 100, the engine sensor 102 and the pump 42 to determine what flow is required and reduce flow or shut down flow when the vehicle is traveling at speeds above the predetermined speed when the electric motor 88 is capable of providing the power assist needed. The power assist needed is based on vehicle speed, engine rpms, road conditions, and/or torque requirements.

The hydraulic steering gear 16 is described as being an integral steering gear. However, the steering gear 16 may be any desired hydraulic power steering system, such as a rack and pinion steering gear.

From the above description of the invention, those skilled in the art will perceive improvements, changes and modifications. Such improvements, changes and modifications within the skill of the art are intended to be covered by the appended claims.

1. A method for turning steerable wheels of a vehicle, the method comprising the steps of:
supplying fluid under pressure to a hydraulic power steering motor with a pump driven by an engine of the vehicle to turn the steerable wheels during operation of the engine;
determining if the engine of the vehicle is shut down; and
applying power assist with an electric motor to turn the steerable wheels when the engine is shut down.

2. The method as set forth in claim 1 wherein the step of applying power assist with the electric motor includes applying a torque to a hand wheel of the vehicle with the electric motor.

3. The method as set forth in claim 1 wherein the step of applying power assist with the electric motor includes applying a torque to an input shaft of a directional control valve that directs fluid from the pump to the hydraulic power steering motor during operation of the engine.

4. The method as set forth in claim 1 further including determining if the vehicle is moving and applying the power assist with the electric motor when the engine is shut down and the vehicle is moving.

5. The method as set forth in claim 1 further including providing a signal indicative of a torque applied to a hand wheel of the vehicle and a signal indicative of a magnitude of rotation applied to the hand wheel and applying the power assist with the electric motor in response to the signals.

6. The method as set forth in claim 1 further including determining the speed of the vehicle and reducing the hydraulic flow provided to the power steering motor by the pump when the speed of the vehicle is above a predetermined speed and applying the power assist with the electric motor when the hydraulic flow has been reduced.

7. An apparatus for turning steerable vehicle wheels, said apparatus comprising:
a hydraulic power steering motor assembly connected with the steerable vehicle wheels;
a pump which is connected with the power steering motor assembly and is driven by an engine of the vehicle to supply fluid under pressure to the power steering motor assembly during operation of the engine;
an electric motor connected with the steerable vehicle wheels to apply power assist to turn the steerable vehicle wheels;
a controller operating the electric motor to apply the power assist when the engine is shut down.

8. An apparatus as set forth in claim 7 further including an engine sensor that sends a signal to the controller indicating the operation of the engine, the controller operating the electric motor in response to the engine sensor indicating that the engine is shut down.

9. An apparatus as set forth in claim 7 wherein the electric motor is connected with a hand wheel of the vehicle and applies a torque to the hand wheel when the engine is shut down.

10. An apparatus as set forth in claim 7 wherein the electric motor is connected with an input shaft of a directional control valve that directs fluid from the pump to the hydraulic power steering motor during operation of the engine and applies a torque to the input shaft when the engine is shut down.

11. The apparatus as set forth in claim 7 further including a vehicle speed sensor that sends a signal to the controller indicating the speed of the vehicle, the controller operating the electric motor in response to the vehicle speed sensor indicating that the vehicle is moving.

12. The apparatus as set forth in claim 7 further including a torque sensor that sends a signal to the controller indicating a torque applied to a hand wheel of the vehicle and a hand wheel sensor that sends a signal to the controller indicating a magnitude of rotation applied to the hand wheel, the controller operating the electric motor in response to the torque sensor and the hand wheel sensor.

13. The apparatus as set forth in claim 7 further including a vehicle speed sensor that sends a signal to the controller indicating the speed of the vehicle, the controller reducing the supply of fluid under pressure to the power steering motor when the speed of the vehicle is above a predetermined speed and operating the electric motor to apply power assist to turn the steerable vehicle wheels.
